(19) United States
(12) Patent Application Publication
(10) Pub. No.: US 2023/0110395 A1
(43) Pub. Date: Apr. 13, 2023

(54) METHOD FOR ASCERTAINING MOVEMENT VARIABLES OF A TWO-WHEELED VEHICLE

(71) Applicant: Robert Bosch GmbH, Stuttgart (DE)

(72) Inventors: Alessandro Moia, Holzgerlingen (DE); Daniel Baumgaertner, Tuebingen (DE); Joseph Reck, Filderstadt (DE); Silas Klug, Magstadt (DE)

(21) Appl. No.: 17/937,845

(22) Filed: Oct. 4, 2022

(30) Foreign Application Priority Data
Oct. 8, 2021 (DE) 10 2021 211 388.5

(51) Int. Cl. B62J 45/412; B62M 6/40; B62J 45/414; G01C 22/00

(52) U.S. Cl. CPC B62J 45/412; B62M 6/40; B62J 45/414; G01C 22/002

(57) ABSTRACT

A method for ascertaining movement variables of a two-wheeled vehicle. The two-wheeled vehicle includes a sensor system including rotational rate, acceleration, and wheel rotational speed sensors. The wheel rotational speed sensor detects at least one measurement pulse per rotation of a wheel of the two-wheeled vehicle. The method includes: acquisition of three-dimensional rotational rates of the two-wheeled vehicle by the rotational rate sensor, acquisition of acceleration values by the acceleration sensor, estimation of a state of movement of the two-wheeled vehicle based on the acquired rotational rates, the state of movement including estimated values for estimated acceleration values and for an estimated speed and for an estimated distance traveled, first correction of the estimated state of movement based on the acquired acceleration values, and ascertaining of an instantaneous speed of the two-wheeled vehicle and/or of a distance traveled by the two-wheeled vehicle, based on the corrected estimated state of movement.

### CROSS-REFERENCE

The present application claims the benefit under 35 U.S.C. § 119 of German Patent Application No. DE 10 2021 211 388.5 filed on Oct. 8, 2021, which is expressly incorporated herein by reference in its entirety.

### FIELD

The present invention relates to a method for ascertaining movement variables of a two-wheeled vehicle, and to a two-wheeled vehicle.

### BACKGROUND INFORMATION

Sensor systems are available for two-wheeled vehicles, by which movement variables such as speed, distances traveled, acceleration, and rotational rates of two-wheeled vehicles can be acquired. The speed is an important movement variable that is for example also used for other systems. For example, during use in an electric bicycle, frequently a regulation of a drive unit of the electric bicycle as a function of the speed is provided. In particular in bicycles, the speed is frequently acquired by so-called reed sensors. For these, standardly a magnet is fastened to a wheel of the bicycle. Using a magnetic sensor fastened to a frame of the bicycle, one pulse is acquired per rotation of the wheel, in order to ascertain the speed of the bicycle based on the frequency of the pulses and the wheel circumference. For reasons of cost, simplicity, and weight, frequently only one single-pulse sensor, with a single magnet on the wheel, is used. However, in particular at low speeds this frequently results in a high degree of inaccuracy. It is also conventional to increase the accuracy using multi-pulse sensors, but this increases the complexity, costs, and weight.

### SUMMARY

In comparison to the above, a method according to an example embodiment of the present invention the present invention is distinguished by a particularly simple and low-cost method by which movement variables of a two-wheeled vehicle can be ascertained very precisely. In particular, a high degree of accuracy can be achieved even at very low speeds. According to an example embodiment of the present invention, the present invention, this is achieved by a method for ascertaining movement variables of a two-wheeled vehicle, the two-wheeled vehicle including a sensor system that has a rotational rate sensor, an acceleration sensor, and a wheel rotational speed sensor. The wheel rotational speed sensor is in particular a rotation sensor, and is designed to detect at least one measurement pulse per rotation of a wheel of the two-wheeled vehicle. Preferably, the wheel rotational speed sensor is a one-pulse reed sensor that has exactly one magnet that is fastened to the wheel and that rotates with the wheel, and in particular has a receiver that detects exactly one measurement pulse when the magnet passes by. According to an example embodiment of the present invention, the method here includes the following steps:
acquisition of rotational rates, in particular three-dimensional, of the two-wheeled vehicle by the rotational rate sensor,
acquisition of acceleration values of the two-wheeled vehicle by the acceleration sensor,
estimation of a state of movement of the two-wheeled vehicle based on the acquired rotational rates, the state of movement including estimated values for estimated acceleration values and for an estimated speed and for an estimated distance traveled,
first correction of the estimated state of movement based on the acquired acceleration values, and
ascertaining an instantaneous speed of the two-wheeled vehicle and/or of a distance traveled by the two-wheeled vehicle based on the corrected estimated state of movement.

In particular ascertained or calculated values of the respective characteristic variables, i.e., the estimated acceleration values, the estimated speed, and the estimated distance traveled, are regarded as estimated values. In other words, in particular a numerical value, preferably including the corresponding unit of measurement, is regarded as an estimated value. In particular, the state of movement per each such characteristic variable includes in each case a separate estimated value. In particular, the estimated values are iteratively optimized by the method in order to enable the desired characteristic variables to be ascertained based thereon.

Preferably, according to an example embodiment of the present invention, the rotational rate sensor acquires three-dimensional rates of rotation that include in each case a rate of rotation about a longitudinal axis, which is oriented in particular in the direction of travel, about a vertical axis, and about a pitch axis that is positioned perpendicular to the longitudinal axis and to the vertical axis.

In other words, in the method, the rotational rate sensor is used to acquire the (in particular three-dimensional) rotational rates, and, based on this, a general state of movement of the two-wheeled vehicle is estimated that also includes further movement variables such as the estimated speed and the estimated distance traveled. Subsequently, this estimated state of movement is corrected based on the additionally obtained acceleration values of the acceleration sensor, in particular based on a comparison of the estimated acceleration values with the actual acceleration values. In particular, here the estimated acceleration values can be corrected directly on the basis of the measured acceleration values. At the same time, preferably based on this correction step, the further movement variables of the state of movement are corrected, in particular the estimated speed and the estimated distance traveled. From this, the instantaneous speed and/or the currently traveled distance of the two-wheeled vehicle can subsequently be ascertained.

The method according to an example embodiment of the present invention is thus distinguished in that particularly extensive and precise sensor data about the movement of the bicycle can be ascertained using a comparatively simple and low-cost sensor system. In particular, a simple and low-cost sensor system can be used to acquire accurate and high-resolution speed values even at low speeds, which is particularly advantageous when used on a bicycle.

Preferred developments of the present invention are disclosed herein.

According to an example embodiment of the present invention, preferably, the method additionally includes the following steps: second correction of the state of movement based on the measurement pulses detected by the wheel rotational speed sensor. Preferably, the second correction takes place each time there is a measurement pulse detected by the wheel rotational speed sensor. In this way, the movement variables can be ascertained with particularly high accuracy, because due to the measurement pulses detected by the wheel rotational speed sensor, whenever such measurement pulses are obtained particularly accurate data are available and can be used to optimize the estimated state of movement.

According to an example embodiment of the present invention, particularly preferably, the second correction is carried out based on the following equation: y2=[x5,old+2πr]. Here, y2 is a corrected value for a distance traveled by the two-wheeled vehicle, x5,old is an old (i.e. past in time) value for the distance traveled by the two-wheeled vehicle, and r is a radius of a wheel of the two-wheeled vehicle. In particular, y2 is the estimated distance traveled of the state of movement. In other words, at each time at which a measurement pulse is detected by the wheel rotational speed sensor, the estimated distance traveled of the state of movement is replaced by the precise measurement value of the wheel rotational speed sensor.

According to an example embodiment of the present invention, preferably, based on the corrected state of movement, one or more of the following movement variables of the two-wheeled vehicle are ascertained: roll angle, pitch angle, and longitudinal acceleration. In this way, information about the current movement of the two-wheeled vehicle can be obtained particularly accurately.

According to an example embodiment of the present invention, further preferably, the first correction is carried out using a non-linear Kalman filter. In this way, a particularly efficient and precise correction of the state of movement can easily be carried out.

According to an example embodiment of the present invention, preferably, the estimation of the state of movement of the two-wheeled vehicle is carried out using a state vector

$$x = [ \begin{matrix}x 1 \\ x 2 \\ x 3 \\ x 4 \\ x 5\end{matrix} ] ,$$

an input vector

$$u = [ \begin{matrix}u 1 \\ u 2 \\ u 3\end{matrix} ] ,$$

and based on the following system equation:

$$\dot{x} = [ \begin{matrix}u 1 + tan ( x 2 ) sin ( x 1 ) u 2 + tan ( x 2 ) cos ( x 1 ) u 3 \\ cos ( x 1 ) u 2 - sin ( x 1 ) u 3 \\ 0 \\ x 3 \\ x 4\end{matrix} ] .$$

In particular, here the input vector u can be regarded as the input to system equation \dot{x}. Here, x1 is a roll angle, x2 is a pitch angle, x3 is a longitudinal acceleration, x4 is a longitudinal speed, and x5 is a distance traveled. In addition, u1, u2, and u3 are the three-dimensional rotational rates. In particular, here system equation \dot{x}corresponds to a temporal change in the state of movement.

According to an example embodiment of the present invention, preferably, the estimation of the state of movement of the two-wheeled vehicle takes place based on a calculation of an integral of system equation \dot{x}. In particular, after the integration of the system equation the correspondingly obtained components of the state of movement can be used directly as estimated values for the acceleration values, the speed, and the distance traveled. Further preferably, the estimation of the state of movement of the two-wheeled vehicle is in addition carried out based on the following equations:

$$R x = [ \begin{matrix}1 & 0 & 0 \\ 0 & cos ( x 1 ) & sin ( x 1 )\end{matrix} ] ,$$

$$Ry = [ \begin{matrix}cos ( x 2 ) & 0 & - sin ( x 2 ) \\ 0 & 1 & 0 \\ sin ( x 2 ) & 0 & cos ( x 2 )\end{matrix} ] ,$$

$$\dot{ψ} = \frac{( u 2 sin ( x 1 ) + u 3 cos ( x 1 ) )}{cos ( x 2 )} ,$$

$$y 1 = R x R y [ \begin{matrix}x 3 \\ - x 4 \dot{ψ} \\ g\end{matrix} ] .$$

Here, \dot{ψ} is a yaw rate of the two-wheeled vehicle and y1 are the estimated acceleration values y1 of the two-wheeled vehicle. A rotational speed of the two-wheeled vehicle about the longitudinal axis is in particular regarded as the yaw rate. In particular, here the first correction takes place by correcting the estimated acceleration values y1.

According to an example embodiment of the present invention, preferably, the method further includes the step: ascertaining a state of standstill of the two-wheeled vehicle based on the estimated state of movement. Preferably, in addition three travel modes can be distinguished here: standstill, movement, and transition. Preferably, the travel modes can be ascertained on the basis of predefined threshold values, for example of the estimated speed. In this way, information can be obtained particularly easily and clearly about a current state of travel of the two-wheeled vehicle. In addition, the ascertained travel states, such as the standstill, can be used to make it possible to carry out further optimizations of the method in order to increase the accuracy of the ascertaining of the state of movement.

$$\dot{x} x = [ \begin{matrix}x 1 \\ x 2\end{matrix} ]$$

According to an example embodiment of the present invention, further preferably, the method additionally includes the steps:

$$\dot{x} x = [ \begin{matrix}x 1 \\ x 2\end{matrix} ] -$$

reducing the state vector x and the system equation to the following states:

$$\dot{x} x = [ \begin{matrix}x 1 \\ x 2\end{matrix} ] and$$

$$\dot{x} = [ \begin{matrix}u 1 + tan ( x 2 ) sin ( x 1 ) u 2 + tan ( x 2 ) cos ( x 1 ) u 3 \\ cos ( x 1 ) u 2 - sin ( x 1 ) u 3\end{matrix} ] ,$$

\dot{x} if no measurement pulses are detected by the wheel rotational speed sensor over at least a predefined period of time, or if a standstill of the vehicle has been ascertained, and

\dot{x}—expansion of the state vector x and of the system equation to the original states before the reduction if measurement pulses are again detected by the wheel rotational speed sensor.

That is, when there is a standstill, or when for some other reason the wheel rotational speed sensor detects no measurement pulses, the state vector x and the system equation \dot{x} are reduced to the respective first two states. In this way, a drift of the estimated values of the state of movement, which can occur when no correction is possible due to the lack of a speed signal, can be avoided.

According to an example embodiment of the present invention, particularly preferably, the method additionally includes the step: ascertaining a steering angle of the two-wheeled vehicle based on the corrected state of movement. Here, an angle between a longitudinal direction of the two-wheeled vehicle and a front wheel of the two-wheeled vehicle, projected onto a plane perpendicular to the vertical axis, i.e. for example a ground plane, can be regarded as the steering angle. The steering angle can be ascertained particularly precisely through the temporally high-resolution and precise acquisition of the state of movement.

According to an example embodiment of the present invention, preferably, the steering angle δ is acquired based on the following equation:

$$δ = arctan ( \frac{\dot{ψ} L}{x 4} ) ,$$

with yaw rate \dot{ψ}, a wheelbase L of the two-wheeled vehicle, and the one longitudinal axis x4. In particular, the wheelbase corresponds to a distance between the two wheel hubs, or axes, of the two-wheeled vehicles. Preferably, it is additionally provided to carry out the calculation of this equation in such a way that the expression in the denominator does not assume any values around zero, in order to avoid numerical problems that would thereby occur. Preferably, for this purpose an ascertained minimum speed is used as longitudinal speed x4. Preferably, the calculation of the steering angle is carried out only during recognized travel of the two-wheeled vehicle, and in particular is prevented when a standstill of the two-wheeled vehicle is recognized.

In addition, the present invention provides a two-wheeled vehicle including a sensor system that has a rotational rate sensor, an acceleration sensor, and a wheel rotational speed sensor. In addition, the two-wheeled vehicle has a control device that is set up to carry out the described method according to the present invention for ascertaining movement variables of the two-wheeled vehicle. Preferably, the wheel rotational speed sensor is a one-pulse reed sensor that has exactly one magnet that is fastened to the wheel and rotates with the wheel. Here, the two-wheeled vehicle is distinguished in that the movement variables can be ascertained with high temporal resolution and high accuracy with a particularly simple and low-cost design of the sensor system.

Preferably, the two-wheeled vehicle is realized as an electrically driven and/or drivable bicycle, which can also be referred to as an electric bicycle.

### BRIEF DESCRIPTION OF THE DRAWINGS

In the following, the present invention is described on the basis of exemplary embodiments in connection with the Figures. In the Figures, functionally identical components have been identified with the same reference characters.

FIG. 1 shows a simplified schematic view of a two-wheeled vehicle having a sensor system and a control device for carrying out a method according to a preferred exemplary embodiment of the present invention.

FIG. 2 shows an alternative view of the two-wheeled vehicle of FIG. 1 in order to illustrate a steering angle.

FIG. 3 shows an alternative view of the two-wheeled vehicle of FIG. 1 in order to illustrate an inclined position.

FIG. 4 shows a simplified schematic view of the carrying out of a method according to the preferred exemplary embodiment of the present invention.

### DETAILED DESCRIPTION OF EXAMPLE EMBODIMENTS

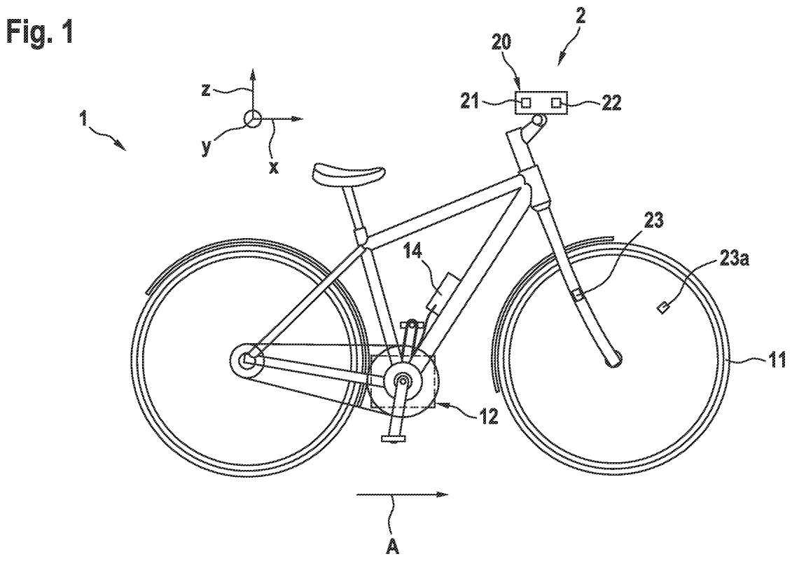

FIG. 1 shows a simplified schematic view of a two-wheeled vehicle 1 having a sensor system 2 and a control device 20 for carrying out a method for ascertaining movement variables of two-wheeled vehicle 1 according to a preferred exemplary embodiment of the present invention.

Two-wheeled vehicle 1 is an electric bicycle that has, in the area of a bottom bracket bearing, a drive unit 12 by which a manually produced pedaling force of a driver of two-wheeled vehicle 1 can be motorically supported. Drive unit 12 is provided with electrical energy by an electrical energy storage device 14.

Control device 20 is situated on a steering handle of two-wheeled vehicle 1, and can for example be part of an onboard computer.

Sensor system 2 has a plurality of sensors. In detail, sensor system 2 has a rotational rate sensor 21 and an acceleration sensor 22, both of which are integrated into control device 20.

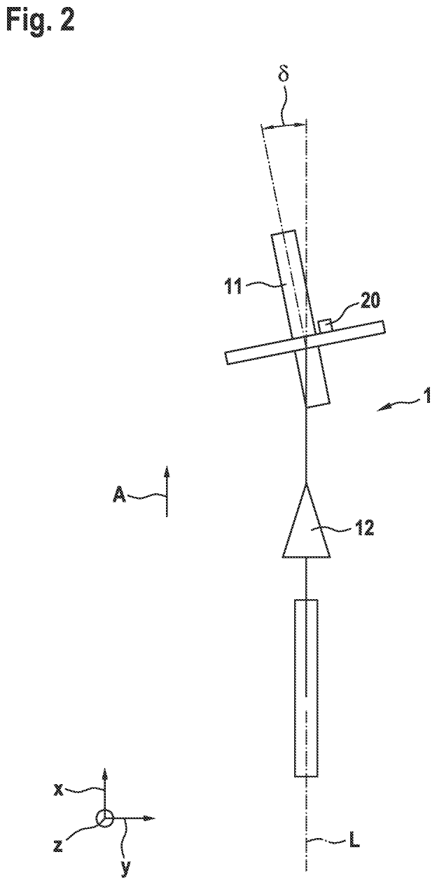

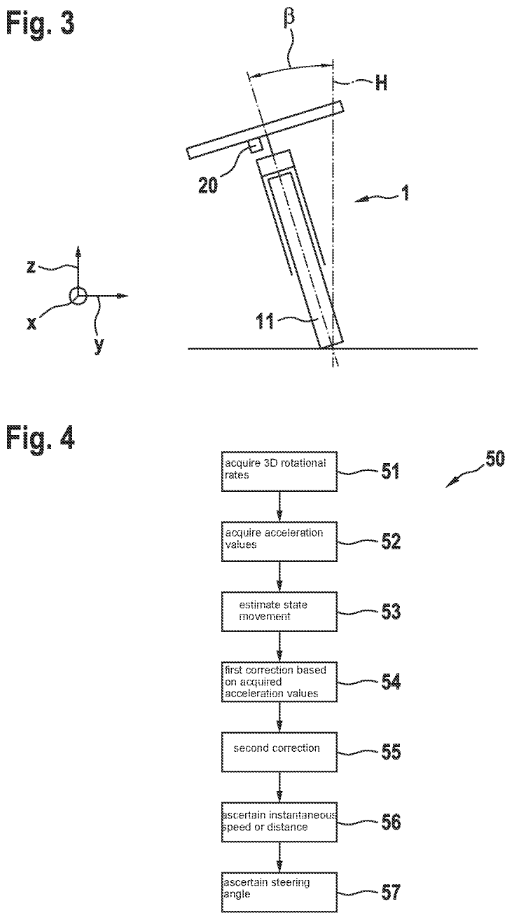

Rotational rate sensor 21 acquires three-dimensional rotational rates of two-wheeled vehicle 1 during travel. A rotational rate is acquired about each of the axes x, y, z indicated in FIG. 1 (see also FIGS. 2 and 3).

Here, the x axis is parallel to a longitudinal axis L of two-wheeled vehicle 1 (see FIG. 2) that, during straight-line travel of two-wheeled vehicle 1, is parallel to a direction of travel A. The z axis corresponds to a vertical axis H (see FIG. 3) that is in particular parallel to a direction of gravitation (not shown) of the Earth's gravitational field. The y axis is perpendicular to the x axis and perpendicular to the z axis. The y axis can also be referred to as the pitch axis. The z axis can also be referred to as the yaw axis.

Acceleration sensor 22 acquires acceleration values of two-wheeled vehicle 1, preferably a total of three acceleration values along each of the axes x, y, z.

In addition, sensor system 2 includes a single-pulse wheel rotational speed sensor 23 that is designed as a rotation sensor in order to detect exactly one measurement pulse per rotation of a wheel 11 of two-wheeled vehicle 1. For this purpose, wheel rotational speed sensor 23 is set up to detect the measurement pulse exactly once per rotation of wheel 11, each time that a magnet 23a, fastened for example to a spoke of wheel 11, passes by. Based on the measurement pulses detected by wheel rotational speed sensor 23, in this way a rotational speed of wheel 11 can be ascertained.

Using method 50, an instantaneous speed of two-wheeled vehicle 1, a distance traveled, and an instantaneous steering angle δ are ascertained as movement variables of two-wheeled vehicle 1.

Steering angle δ is illustrated in FIG. 2. FIG. 2 shows a view of two-wheeled vehicle 1 along the z axis. As can be seen in FIG. 2, steering angle δ corresponds to an angle between longitudinal axis L and front wheel 11. During travel straight ahead, steering angle δ is equal to zero, and becomes correspondingly higher the smaller a radius of the curve traveled through by two-wheeled vehicle 1 becomes.

During travel in a curve with two-wheeled vehicle 1, two-wheeled vehicle 1 is brought into an inclined position, as shown in FIG. 3. FIG. 3 schematically shows an angle of inclination β of two-wheeled vehicle 1. Angle of inclination β is the angle by which two-wheeled vehicle 1 is inclined out of vertical axis H.

In the following, the carrying out of method 50 for ascertaining the movement variables of two-wheeled vehicle 1 is described with reference to FIG. 4.

In method 50, first the rotational rate sensor 21 acquires 51 the three-dimensional rotational rates of two-wheeled vehicle 1. At the same time, the acceleration values of two-wheeled vehicle 1 are acquired 52 by acceleration sensor 22. Based on the acquired three-dimensional rotational rates, there subsequently takes place an estimation 53 of a state of movement of two-wheeled vehicle 1.

The state of movement of two-wheeled vehicle 1 includes estimated values for estimated acceleration values and for an estimated speed, and also for an estimated distance traveled. In detail, the estimation of the state of movement takes place using a state vector that has the following parameters: roll angle, pitch angle, longitudinal acceleration, longitudinal speed, and distance traveled. In particular, here the roll angle corresponds to the angle of inclination β, i.e. a deflection or rotation of two-wheeled vehicle 1 about vertical axis H. Preferably, the pitch angle corresponds to a deflection or rotation of two-wheeled vehicle 1 about the y axis, i.e., transverse to vertical axis H.

Based on the state vector and an input vector, the input vector having the three-dimensional rotational rates, a system equation is subsequently created that represents in particular a temporal change of the state vector.

Subsequently, the state of movement of two-wheeled vehicle 1 is estimated 53 by calculating an integral of this system equation. As a result, the estimated movement variables of two-wheeled vehicle 1 are obtained.

There subsequently follow correction steps 54, 55 of the state of movement. First, there takes place a first correction 54 of the state of movement based on the acceleration values actually acquired by acceleration sensor 22.

In addition, a second correction 55 of the state of movement takes place every time a measurement pulse of wheel rotational sensor 23 is detected. In detail, the state of movement is here corrected based on the distance actually traveled, ascertained by wheel rotational speed sensor 23. Because the distance actually traveled can be determined very accurately based on the geometrical relationship of the measurement pulses to the wheel circumference of wheel 11, second correction 55 can carry out a particularly accurate correction step of the state of movement.

Subsequently, based on the corrected state of movement, steering angle δ of two-wheeled vehicle 1 can be ascertained 57.

Moreover, method 50 can be carried out in a modified form (not shown) that additionally takes into account a standstill of two-wheeled vehicle 1. Here, in addition an ascertaining of a standstill of two-wheeled vehicle 1 takes place based on the estimated state of movement.

When a standstill of two-wheeled vehicle 1 has been ascertained, the state vector and the system equation can be reduced to the first two states. In this way, the estimated movement variables can be prevented from drifting as time progresses due to the absence of a measurement pulse that can be used for second correction 55. As soon as it has been ascertained that two-wheeled vehicle 1 is again moving, or as soon a measurement pulse has again been ascertained by wheel rotational speed sensor 23, the state vector and the system equation are again expanded to the original states before the reduction, so that subsequently an accurate determination of all the movement variables is again enabled.

Alternatively to a standstill of two-wheeled vehicle 1, an absence of a measurement pulse of wheel rotational speed sensor 23 can also be used to reduce the state vector and the state equation to the first two states.

The state of movement, corrected once or twice, thus has particularly accurate estimated values for the movement variables of two-wheeled vehicle 1. In particular, in this way on the basis of the corrected state of movement a desired movement variable, such as the speed, can be read off at any desired time and for example used for further systems or methods of two-wheeled vehicle 1. In addition, using method 50 the movement variables of two-wheeled vehicle 1 can be precisely ascertained even at very low speed, because method 50 is based in particular on the measurement values of rotational rate sensor 21 and acceleration sensor 22, which are capable of supplying precise and reliable measurement values even at low speeds.

What is claimed is:

1. A method for ascertaining movement variables of a two-wheeled vehicle, the two-wheeled vehicle including a sensor system that has a rotational rate sensor, an acceleration sensor, and a wheel rotational speed sensor, the wheel rotational speed sensor being configured to detect at least one measurement pulse per rotation of a wheel of the two-wheeled vehicle, the method comprising the following steps:
acquiring three-dimensional rotational rates of the two-wheeled vehicle, by the rotational rate sensor;
acquiring acceleration values of the two-wheeled vehicle by the acceleration sensor;
estimating a state of movement of the two-wheeled vehicle based on the acquired rotational rates, the state of movement including estimated values for estimated acceleration values, for an estimated speed, and for an estimated distance traveled;
a first correcting of the estimated state of movement based on the acquired acceleration values; and
ascertaining an instantaneous speed of the two-wheeled vehicle and/or a distance traveled by the two-wheeled vehicle, based on the corrected estimated state of movement.

2. The method as recited in claim 1, further comprising the following step:
a second correcting of the estimated state of movement based on the measurement pulses detected by the wheel rotational speed sensor.

3. The method as recited in claim 2, wherein the second correction is carried out based on the following equation: y2=[x5, old+2 πr] with a corrected value y2 for the distance traveled by the two-wheeled vehicle, an old value x5, old for the distance traveled by the two-wheeled vehicle, and a radius r of a wheel of the two-wheeled vehicle.
y2=[x5,old+2πr]

4. The method as recited in claim 1, wherein one or more of the following movement variables of the two-wheeled vehicle being ascertained based on the corrected estimated state of movement: roll angle, pitch angle, longitudinal acceleration.

5. The method as recited in claim 1, wherein the first correction is carried out using a non-linear Kalman filter.

6. The method as recited in claim 1, the estimation of the state of movement of the two-wheeled vehicle takes place using a state vector
$$x = [ \begin{matrix}x 1 \\ x 2 \\ x 3 \\ x 4 \\ x 5\end{matrix} ] ,$$
with a roll angle x1, a pitch angle x2, a longitudinal acceleration x3, a longitudinal speed x4, and a distance traveled x5, and using an input vector
$$u = [ \begin{matrix}u 1 \\ u 2 \\ u 3\end{matrix} ] ,$$
with the three-dimensional rotational rates u1, u2, and u3, and based on the following system equation:
$$\dot{x} = [ \begin{matrix}u 1 + tan ( x 2 ) sin ( x 1 ) u 2 + tan ( x 2 ) cos ( x 1 ) u 3 \\ cos ( x 1 ) u 2 - sin ( x 1 ) u 3 \\ 0 \\ x 3 \\ x 4\end{matrix} ] .$$

7. The method as recited in claim 6, wherein the estimation of the state of movement of the two-wheeled vehicle takes place based on a calculation of an integral of the system equation \dot{x}.

8. The method as recited in claim 7, the estimation of the state of movement of the two-wheeled vehicle further being carried out based on the following equations:
$$Rx = [ \begin{matrix}1 & 0 & 0 \\ 0 & cos ( x 1 ) & sin ( x 1 )\end{matrix} ] ,$$
$$Ry = [ \begin{matrix}cos ( x 2 ) & 0 & - sin ( x 2 ) \\ 0 & 1 & 0 \\ sin ( x 2 ) & 0 & cos ( x 2 )\end{matrix} ] ,$$
$$\dot{ψ} = \frac{( u 2 sin ( x 1 ) + u 3 cos ( x 1 ) )}{cos ( x 2 )} ,$$
$$y 1 = R x R y [ \begin{matrix}x 3 \\ - x 4 \dot{ψ} \\ g\end{matrix} ] .$$
with a yaw rate \dot{ψ} of the two-wheeled vehicle and the estimated acceleration values y1 of the two-wheeled vehicle.

9. The method as recited in claim 1, further comprising the step:
ascertaining a standstill of the two-wheeled vehicle based on the estimated state of movement.

10. The method as recited in claim 6, further comprising the following steps:
reducing the state vector x and the system equation \dot{x} to the following states:
$$x = [ \begin{matrix}x 1 \\ x 2\end{matrix} ] and$$
$$\dot{x} = [ \begin{matrix}u 1 + tan ( x 2 ) sin ( x 1 ) u 2 + tan ( x 2 ) cos ( x 1 ) u 3 \\ cos ( x 1 ) u 2 - sin ( x 1 ) u 3\end{matrix} ] ,$$
when the wheel rotational speed sensor detects no measurement pulses over a prespecified period of time, or if a standstill of the vehicle has been ascertained, and
expanding the state vector x and the system equation \dot{x} to the original states before the reduction when measurement pulses are again detected by the wheel rotational speed sensor.

11. The method as recited in claim 1, further comprising the following step:
ascertaining a steering angle of the two-wheeled vehicle based on the corrected estimated state of movement.

12. The method as recited in claim 8, further comprising the following step:
ascertaining a steering angle δ of the two-wheeled vehicle based on the corrected estimated state of movement;
wherein the ascertaining of the steering angle δ is carried out based on the following equation:
$$δ = arctan ( \frac{\dot{ψ} L}{x 4} ) ,$$
with a wheelbase L of the two-wheeled vehicle (1).

13. A two-wheeled vehicle, comprising:
a sensor system including a rotational rate sensor, an acceleration sensor, and a wheel rotational speed sensor; and
a control device configured to:
acquire three-dimensional rotational rates of the two-wheeled vehicle, using the rotational rate sensor,
acquire acceleration values of the two-wheeled vehicle using the acceleration sensor,
estimate a state of movement of the two-wheeled vehicle based on the acquired rotational rates, the state of movement including estimated values for estimated acceleration values, for an estimated speed, and for an estimated distance traveled,
a first correction of the estimated state of movement based on the acquired acceleration values; and
ascertain an instantaneous speed of the two-wheeled vehicle and/or a distance traveled by the two-wheeled vehicle, based on the corrected estimated state of movement.

14. The two-wheeled vehicle as recited in claim 13, wherein the two-wheeled vehicle is an electrically driven bicycle.
